(19) United States
(12) Patent Application Publication
(10) Pub. No.: US 2012/0179438 A1
(43) Pub. Date: Jul. 12, 2012

(54) Robust Solution of Difficult Sub-Problems Arising from Numerical Reservoir Simulation

(75) Inventor: Andrew Priestley, Abingdon (GB)

(73) Assignee: SCHLUMBERGER TECHNOLOGY CORPORATION, Sugar Land, TX (US)

(21) Appl. No.: 13/004,711

(22) Filed: Jan. 11, 2011

(51) Int. Cl. G06F 17/11

(52) U.S. Cl. 703/2

(57) ABSTRACT

Methods and systems for providing robust solutions for sub-problems arising from numerical simulations of reservoirs and the like are disclosed. In at least one embodiment, a method of solving a system of non-linear equations in accordance with the present disclosure includes: attempting to iteratively achieve a solution of a portion of the system using one or more iterative solution techniques; determining that the attempting has failed to iteratively achieve the solution of the portion of the system using one or more iterative solution techniques; and responsive to the determination that the attempting has failed, attempting to achieve an interval-based solution of the portion of the system using an interval-based solution technique.

### FIELD OF THE INVENTION

The present disclosure relates to computational simulation and analysis of subterranean reservoirs, including hydrocarbon reservoirs and the like.

### BACKGROUND

Many physical systems are governed by systems of partial differential equations that are too complex to solve with analytical methods, and so they are approximated and then solved numerically using computers. A common way to accomplish the approximation is to discretise the spatial and temporal domains using finite difference, finite volume, or finite element techniques. At some time tⁿ we assume we have an acceptably accurate solution for all the variables at all the grid points (or however else the approximate solution has been represented). We denote this approximate solution as Xⁿ.

Now suppose we wish to advance the solution in time by an amount Δt, that is tⁿ⁺¹=tⁿ+Δt, in order to find Xⁿ⁺¹. Depending on the method chosen for approximation of the partial differential equations we will need to solve a system of the form

F(Xⁿ⁺¹,Xⁿ,Δt)=0 (1)
where we say that the solution at the new time is a function, F, of itself, Xⁿ⁺¹, the solution at the previous time, Xⁿ, and the timestep Δt. Without loss of generality the solution is assumed to be only a function of one preceding timestep.

Depending on the choice of numerical approximation used it may be possible to rewrite Equation (1) as

Xⁿ⁺¹+f(Xⁿ,Δt)=0 (2)
in which case the solution at the new time level can be immediately written down. In some applications areas like reservoir simulation, however, it is considered advantageous to use numerical schemes that cannot be written in the form of (2). This means that a non-linear iterative method is required to solve (1) for Xⁿ⁺¹. So, given an initial guess for Xⁿ⁺¹₀ (it is quite common to put Xⁿ⁺¹₀=Xⁿ) we then find the next approximation for Xⁿ⁺¹ from the equation

Xⁿ⁺¹ₖ₊₁=Xⁿ⁺¹ₖ−G(Xⁿ⁺¹ₖ,Xⁿ,Δt) (3)
and continue until the iteration is deemed to have converged. For example, one very popular method is Newton's method. If we write

R=F(Xⁿ⁺¹ₖ,Xⁿ,Δt) (4)
and

J=∂R/∂Xⁿ⁺¹ₖ (5)
where R is referred to as the residual and J the Jacobian, then

G(Xⁿ⁺¹ₖ,Xⁿ,Δt)=J⁻¹R (6)

Although desirable results have been achieved using the above-noted conventional methods, there is considerable room for improvement. For example, as described more fully below, using at least some conventional solution methods, considerable computational time may be expended without convergence to an acceptable solution, or before it is determinable that an acceptable solution is unattainable.

### SUMMARY

The present disclosure relates to robust solutions for sub-problems arising from numerical simulations of reservoirs and the like. Methods and systems in accordance with the teachings of the present disclosure may advantageously provide improved robustness, and improved computational efficiency, in comparison with conventional methods.

In at least one embodiment, a method of solving a system of non-linear equations in accordance with the present disclosure includes: attempting to iteratively achieve a solution of a portion of the system using one or more iterative solution techniques; determining that the attempting has failed to iteratively achieve the solution of the portion of the system using one or more iterative solution techniques; and responsive to the determination that the attempting has failed, attempting to achieve an interval-based solution of the portion of the system using an interval-based solution technique.

This summary is merely intended to provide a brief synopsis of one or more possible implementations of, and possible aspects or advantages of, systems and methods in accordance with at least some embodiments of the present disclosure. This summary is further intended as merely an aid to the reader's understanding of such particular embodiments, and is not intended to define or limit other embodiments of systems and methods disclosed elsewhere herein.

### BRIEF DESCRIPTION OF THE DRAWINGS

The detailed description is described with reference to the accompanying figures, in which similar or identical reference numerals may be used to identify common or similar elements.

FIG. 1 shows a schematic view of an oilfield operation that may be simulated in accordance with the teachings of the present disclosure.

FIG. 2 shows a representative computational grid that may be used to simulate the oilfield operation of FIG. 1.

FIG. 3 is a flowchart of an embodiment of an exemplary process in accordance with the teachings of the present disclosure.

FIG. 4 is a flowchart of an embodiment of another exemplary process in accordance with the teachings of the present disclosure.

FIG. 5 illustrates an exemplary environment in which various embodiments of systems and methods in accordance with the teachings of the present disclosure can be implemented.

### DETAILED DESCRIPTION

This disclosure is directed to methods and systems for robust solutions for sub-problems arising from numerical simulations of reservoirs and the like. More specifically, embodiments of methods and systems in accordance with the teachings of the present disclosure may advantageously provide processes that attempt to solve a sub-problem of a reservoir simulation (e.g. a well model sub-problem, an isolated flash calculation, etc.) using a conventional method, and if the conventional method fails to provide a suitably converged solution, a switch to an interval-based solution method (e.g. an Interval Newton method, Krawczyk method, etc.) is performed which may provide a unique solution, or which may determine that the sub-problem should be closed. By switching to the interval-based solution method to resolve one or more sub-problems of the overall reservoir simulation, overall computational efficiencies may be substantially improved, and costs associated with the overall reservoir solution process may be substantially reduced.

Underlying Rationale

A possible problem with at least some conventional solution processes, such as those outlined in the Background section above, is that non-linear iterative methods, and Newton's method in particular, cannot in general be guaranteed to converge to a solution. A common strategy is, if the method hasn't converged sufficiently quickly, to replace the time-step Δt by a fraction of its value and try again. In reservoir simulation, however, we typically deal with systems with millions of unknowns, and problems with tens of millions (or more) of unknowns are increasingly common. Therefore, failure to solve the equations represented by Equation (6) above can be very expensive in terms of computer time.

In accordance with the present disclosure, however, by using interval arithmetic, an interval-based solution method can be implemented (e.g. an Interval Newton method, Krawczyk method, etc.) where, under certain assumptions, convergence can be guaranteed. In particular, as long as an interval contains the solution, there is no need to pick an initial starting point for the iteration ‘sufficiently close’ to the true solution which can be a problem for the usual Newton's method.

Interval arithmetic is generally known, and interval-based solution methods have previously been applied in a variety of other scientific fields. Unless otherwise stated, the term interval-based solution method should be interpreted to include any suitable interval-based solution methods that have been formulated for solving systems of non-linear equations, including Interval Newton methods, Krawczyk methods, or any other suitable interval-based methods. Descriptions of suitable formulations of the above-referenced interval-based methods, and other suitable interval-based methods, may be found, for example, in the following publications, which publications are hereby incorporated by reference: Methods and Applications of Interval Analysis by Ramon E. Moore, Interval Methods for Systems of Equations by Arnold Neumaier, Interval Methods for Nonlinear Equation Solving Applications by C. Ryan Gwaltney et al., or LP-Based Strategy for Modeling and Optimization Using Interval Methods by Youdong Lin et al.

There are possible problems, however, with using the interval-based solution method for reservoir simulation. A possible problem is simply the cost of doing the calculations with interval arithmetic. In interval arithmetic, a simple multiplication of two intervals [a,b]*[c,d], where nothing is known about the signs of the quantities a priori, becomes four multiplications and two logical evaluations, represented as: [a,b]*[c,d]=[min(a*c,a*d,b*c,b*d), max(a*c,a*d,b*c,b*d)]. Therefore, interval-based solution methods for reservoir simulation may be more computationally intensive in comparison with alternate, conventional solution techniques.

Similarly, another possible problem may be caused by the splitting of intervals. Consider dividing the interval [1,2] by the interval [−1,1]. The answer is a union of two intervals [−∞,−1] ∪ [1,∞]. This is not always purely an artifact of the method. If we try to solve x²−4=0, for example, on the interval xε [−10,10] with an initial guess of x₀=0, then the first interval-based solution method iteration produces the two intervals [−10, −4/20] and [4/20, 10]. These intervals then converge, correctly, to the two solutions −2 and 2. Sometimes, though, intervals are created that do not contain solutions. For example, if we solve a similar problem to that above but replace the equation with x²+1=0 then the first iteration of the interval-based solution method produces two intervals [−10, −1/20] and [1/20, 10]. With further iterations these intervals do become the empty sets correctly telling us that there is no solution to this problem. It is quite easy to produce fairly simple equations that have one real solution and yet produce multiple intervals where all but the one containing the solution will disappear. However, with not knowing which interval does contain the solution, the calculations must proceed on all the intervals, which again may be relatively computationally intensive in comparison with alternate methods.

In reservoir simulation, the algorithms used for calculating the fluid flow between the grid blocks may contain logic. For example, in a possible embodiment, such logic may provide as follows: if the flow is left to right, one set of property values may be used, whereas if the flow is right to left an alternative set may be used. If the interval of flow values, like the examples above, contains values for both cases then the interval may have to be split. This situation could easily happen at many cells and when dealing with millions of unknowns solving Equation (6) for all these separate intervals, may again be relatively computationally intensive in comparison with alternate methods.

For the foregoing reasons, solution of systems of non-linear equations (e.g. such as those represented by Equation (6)) may be improved by a combined approach that includes one or more attempts to solve a portion of the system of non-linear equations using a conventional iterative method (e.g. Newton's method), but if convergence is not achieved using such a conventional iterative method, then the portion of the system of non-linear equations (i.e. one or more sub-problems) may be solved using a more robust, but possibly more computationally intensive, interval-based solution method. Since the interval-based solution method may achieve one or more solutions to the one or more sub-problems where conventional iterative methods may not, the entire simulation of the system of non-linear equations need not be re-solved due to a failure to solve the one or more sub-problems, and thus, overall computational efficiencies may be improved and costs reduced.

Exemplary Processes

In general, embodiments of methods and systems in accordance with the teachings of the present disclosure will now be described. Such methods and systems may advantageously allow analysts to make use of the power of an interval-based solution method (e.g. to guarantee convergence to a solution, or to identify no solution or multiple solutions) in at least some situations by using it for solving relatively-smaller sub-problems where conventional methods may fail to successfully converge, as described more fully below.

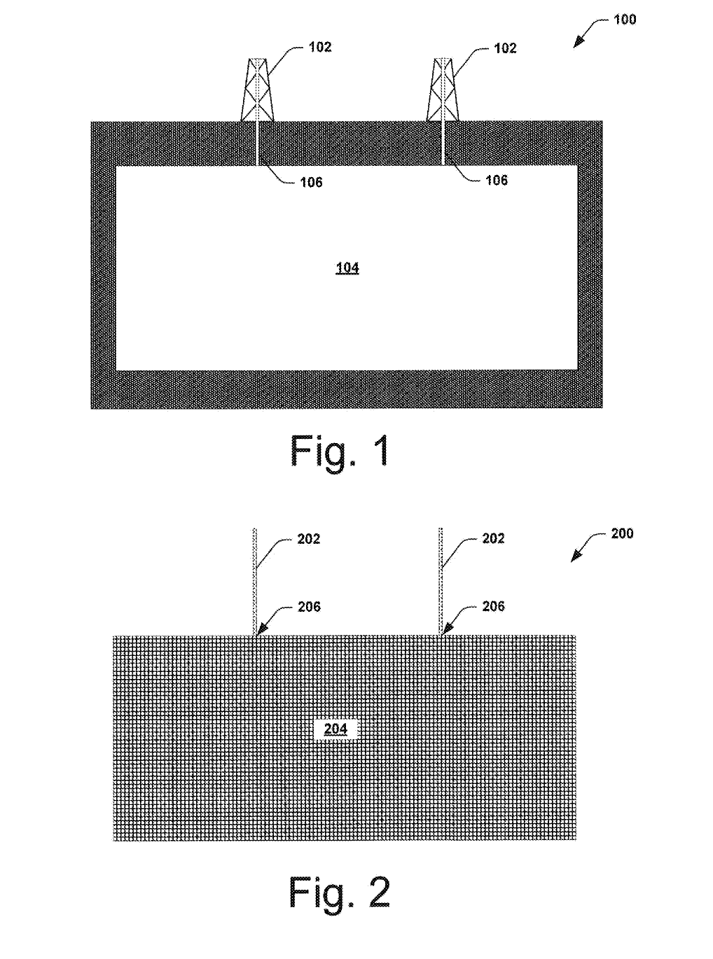

A specific instance will now be described of how the general idea can be used to speed up the solution time of a commercial reservoir simulation. For example, FIG. 1 shows a simplified, schematic view of an oilfield operation 100 that may be simulated in accordance with the teachings of the present disclosure. In this embodiment, the oilfield operation 100 includes a pair of wells 102. Each well 102 is configured to extract hydrocarbons from a subterranean reservoir 104 via a wellbore 106.

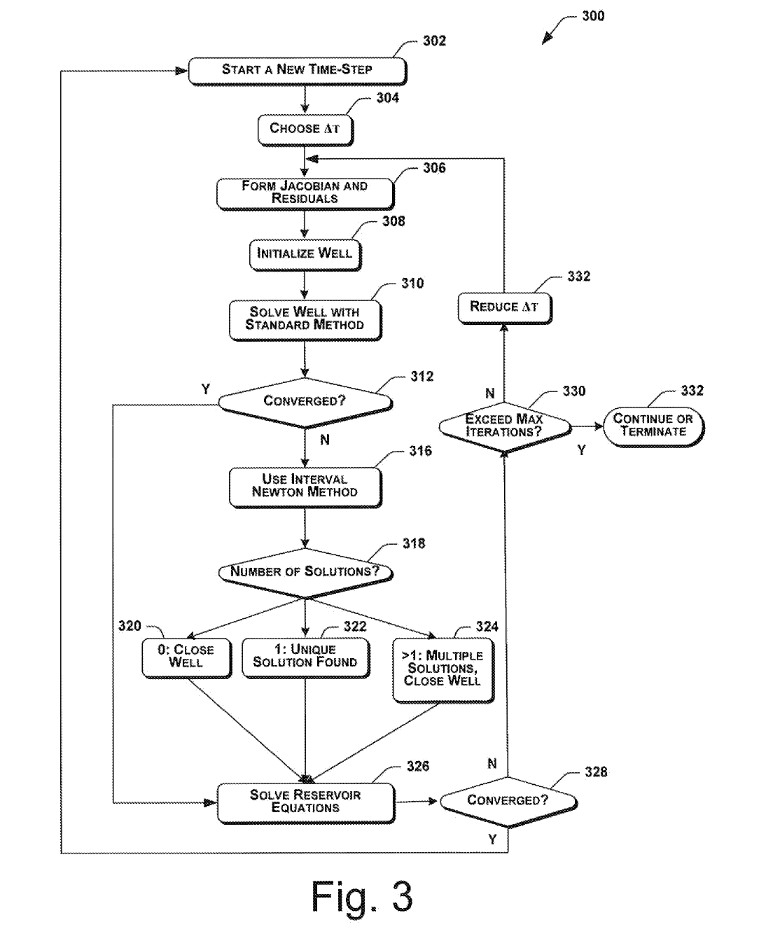

A common strategy for solving the equations represented by Equation (6) generated by a commercial reservoir simulator is to distinguish between variables associated with the reservoir and those associated with the well model, as follows:

$$X = ( \begin{matrix}{X}_{r} \\ {X}_{w}\end{matrix} )$$

$$R = ( \begin{matrix}{R}_{r} \\ {R}_{w}\end{matrix} )$$

$$and$$

$$J = ( \begin{matrix}{J}_{rr} & {J}_{rw} \\ {J}_{wr} & {J}_{ww}\end{matrix} )$$

where the subscripts “r” and “w” refer to the reservoir and well variables, respectively. The Jacobian matrix may then be split into blocks that only depend on the reservoir variables, that only depend on the well variables, and blocks that model the connection between the well(s) and the reservoir. To illustrate this point, FIG. 2 shows a representative computational grid 200 that may be used to perform simulations of the well operation 100 of FIG. 1. In this embodiment, the computational grid 200 includes well portions 202 corresponding to the area within the wellbores 106, a reservoir portion 204 corresponding to the area within the reservoir 104, and transition portions 106 corresponding to the connection between the wells 102 and the reservoir 104.

The one or more wells may then be solved independently of the reservoir, that is, at fixed reservoir conditions. Indeed each well can be solved as an independent non-linear problem. The number of variables to solve for each well can range from 4 to perhaps a few hundred for a very complicated well. Even in a complex case, however, it is a problem many orders of magnitude smaller than the complete reservoir problem. The cost (computer time) for obtaining a solution to the well equations is usually considered negligible compared to the solution time for the reservoir variables. However, should even just one of the wells fail to converge then the whole problem must be re-solved.

Conventional solution methods (e.g. Newton's method) can fail to solve the well equations for a variety of reasons. Often such failure may be due to a poor starting value, such as may occur when a well is initially opened and there is no previous solution to use as an initial value and a heuristic solution is used which may not be very good in all circumstances. Alternately, such failure may occur when a well changes control mode (e.g. such that a solution from a previous time-step is no longer ‘close’), or it can be more subtle changes that lead to a change of direction of the flows in the well or into and out of the well again (e.g. such that a solution from a previous time-step is no longer close enough for Newton's method to converge). Whatever the cause of the non-convergence, processes and systems in accordance with the present disclosure may switch from a conventional solution method to the interval-based solution method (e.g. an Interval Newton method, Krawczyk method, etc.). While this may be more expensive than the conventional method, solution of a well model using the interval-based solution method is typically negligible (or acceptably small) compared to the cost of re-solving the whole reservoir problem.

For example, FIG. 3 is a flowchart of an embodiment of an exemplary process 300 in accordance with the teachings of the present disclosure. In this embodiment, the process 300 includes starting a new (or initial) time step at 302, and choosing a time increment (Δt) at 304. The Jacobian and residual(s) are formed at 306, and variables of a well model are initialized at 308. The process 300 further includes solving (or attempting to solve) the well model using a standard well-solution method at 310.

A determination is performed at 312 to determine whether a converged solution has been achieved using the standard method (at 310). If so, the process 300 proceeds to solve the reservoir equations at 314. If it is determined, however that a converged solution has not been achieved at 312, the process 300 proceeds to solving the well solution using an interval-based solution method (e.g. an Interval Newton method, Krawczyk method, etc.) at 316.

Another determination is performed at 318 to determine a number of solutions that exist based on the interval-based solution method (at 316). If the number of solutions determined at 318 is zero, then the well is closed at 320. If the number of solutions determined at 318 is one, then the unique solution is assigned to the well at 322. Finally, if the number of solutions determined at 318 is greater than one, then the well is closed at 324.

With continued reference to FIG. 3, the process 300 then proceeds to solve the reservoir equations at 326, and a determination is performed at 328 to determine whether the reservoir solution has converged. If so, then the process 300 returns to starting a new time step at 302, and repeating the above-described operations 302 through 328 for the new time step.

If it is determined (at 328) that the reservoir solution has not converged, then the process 300 determines at 330 whether a maximum number of iterations has been exceeded (or reached). If not, then the process 300 reduces the time increment (Δt) at 332, and returns to forming the Jacobian and residual(s) at 306, and repeats the above-described operations 306 through 330 using the reduced time increment. Once it is determined that the maximum number of iterations has been exceeded (or reached) at 330, the process 300 continues to other operations (or terminates) at 334.

It will be appreciated that, in at least some embodiments, the process 300 includes closing a well in case of multiple solutions (at 324) or in the case of no solutions (at 320). This makes sense in that it means we only have to find that more than one solution exists and need not solve every interval to completion. However, it is possible to replace the decision with one that picks the solution on other grounds. Thus, an aspect of the process 300 is that there is no failure from the solution of the well equations, which means that there is no need to re-do a time-step due to convergence problems that may be experienced with the well equations.

It should also be appreciated that alternate embodiments of methods in accordance with the present disclosure may be conceived, and that the invention is not limited to the particular embodiment(s) described above and shown in FIG. 3. For example, in alternate embodiments, one or more of the above-described operations may be eliminated or combined with other operations, or may be replaced with other operations. Similarly, in further embodiments, one or more of the above-described operations may be performed in a different order than described above or shown in FIG. 3. Of course, additional operations may be added to create still further embodiments of methods and systems in accordance with the teachings of the present disclosure.

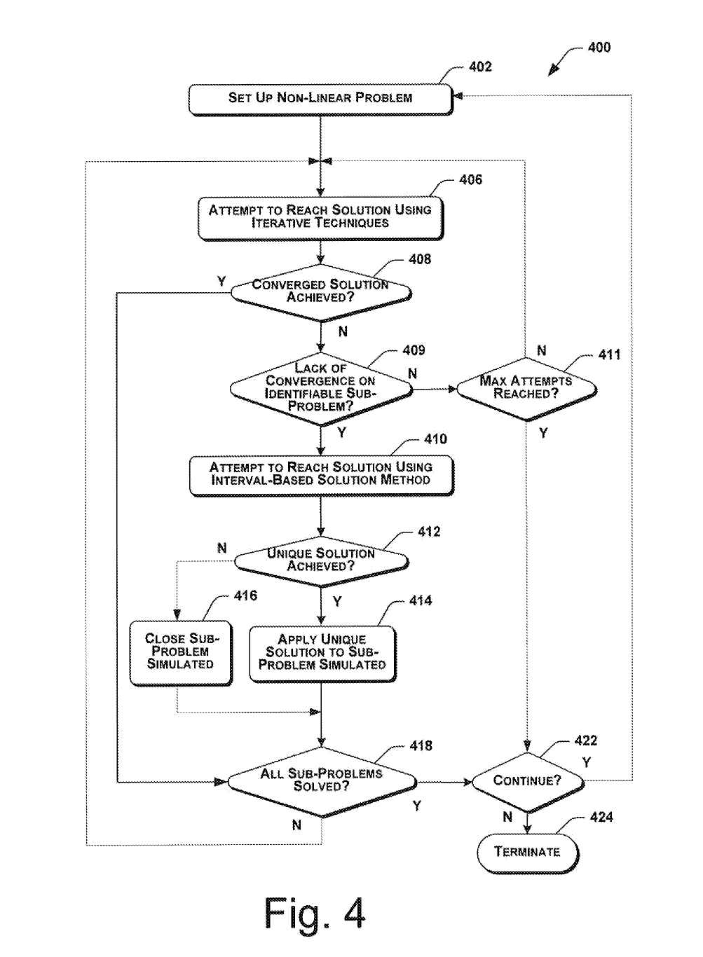

For example, FIG. 4 is a flowchart of an embodiment of another exemplary process 400 in accordance with the teachings of the present disclosure. In this embodiment, the process 400 includes performing set up operations of a non-linear problem at 402 (e.g. generating or providing a computational grid, establishing boundary conditions, selecting computational tools, initializing variables, etc.). At 406, a solution is attempted to be generated on at least a sub-problem of the system being simulated (e.g. a well portion, a reservoir portion, or other portion) using standard iterative techniques.

At 408, the process 400 determines whether a converged solution has been achieved using the iterative techniques. If not, the process 400 determines whether the lack of convergence is attributable to an identifiable sub-problem at 409. If the lack of convergence is not attributable to an identifiable sub-problem (at 409), then the process 400 returns to 406 and attempts (or re-attempts) to achieve convergence of a solution using an iterative technique. Of course, if convergence is not achieved in a reasonable number of attempts (determined at 411), then the process 400 may terminate (or continue to other operations) at 422.

If it is determined (at 409), however, that the convergence is attributable to an identifiable sub-problem, then the process 400 attempts to reach a solution of the sub-problem using an interval-based solution method (e.g. Interval Newton method, etc.) at 410. At 412, a determination is made whether a unique solution has been reached (i.e. one solution found). If so, the unique solution is applied to the sub-problem of the system being simulated at 414. Conversely, if no unique solution has been reached, then the process 400 closes the sub-problem of the system being simulated at 416.

At 418, a determination is made whether all portions of the system have been solved (or closed). If not, the process 400 proceeds to the next portion of the system at 420, returns to 406, and attempts to reach a solution on the next sub-problem of the system using iterative techniques at 406. The above-described operations 406 through 418 are then repeated for each successive sub-problem of the system being simulated.

Once all portions of the system have been solved (or closed) at 418, the process 400 determines whether to continue to solve other non-linear problems at 422. If solution of other problems is desired, then the process 400 returns to 402 to set up a new non-linear problem, and the above-described operations 402 through 422 are repeated for the new non-linear problem. Alternately, the process 400 may terminate at 422.

Exemplary Environment

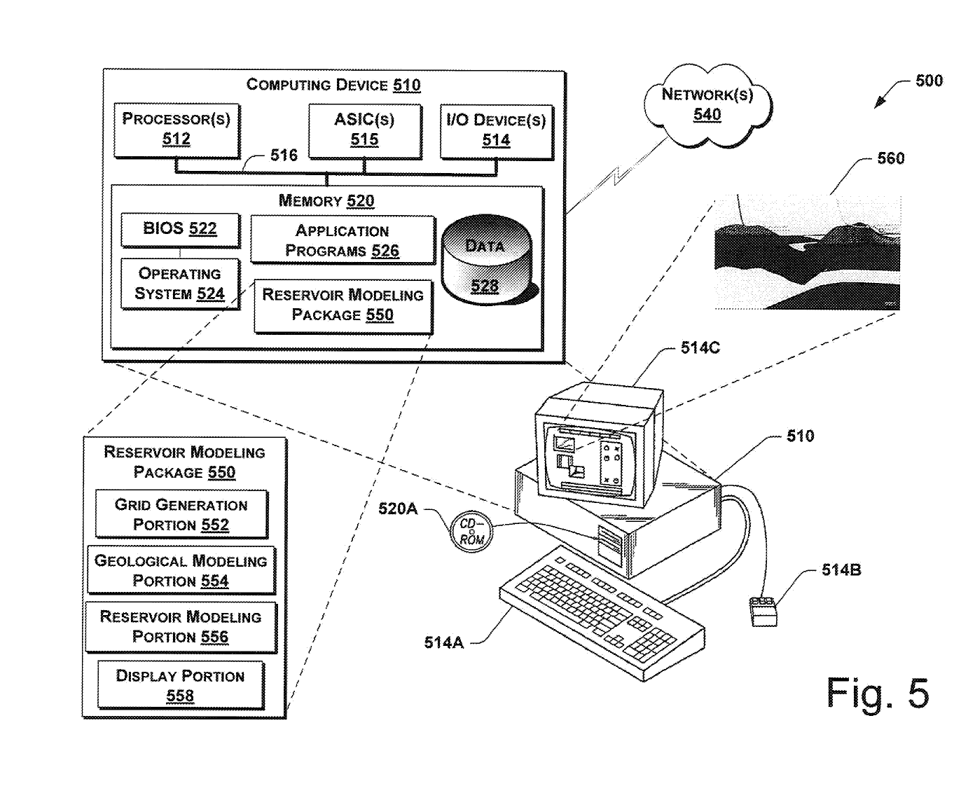

Systems and methods for providing robust solutions for sub-problems arising from numerical simulations of reservoirs and the like in accordance with the teachings of the present disclosure may be implemented in a variety of computational environments. For example, FIG. 5 illustrates an exemplary environment 500 in which various embodiments of systems and methods in accordance with the teachings of the present disclosure can be implemented. In this implementation, the environment 500 includes a computing device 510 configured in accordance with the teachings of the present disclosure. In some embodiments, the computing device 510 may include one or more processors 512 and one or more input/output (I/O) devices 514 coupled to a memory 520 by a bus 516. One or more Application Specific Integrated Circuits (ASICs) 515 may be coupled to the bus 516 and configured to perform one or more desired functionalities described herein.

The one or more processors 512 may be composed of any suitable combination of hardware, software, or firmware to provide the desired functionality described herein. Similarly, the I/O devices 514 may include any suitable I/O devices, including, for example, a keyboard 514A, a cursor control device (e.g. mouse 514B), a display device (or monitor) 514C, a microphone, a scanner, a speaker, a printer, a network card, or any other suitable I/O device. In some embodiments, one or more of the I/O components 514 may be configured to operatively communicate with one or more external networks 540, such as a cellular telephone network, a satellite network, an information network (e.g. Internet, intranet, cellular network, cable network, fiber optic network, LAN, WAN, etc.), an infrared or radio wave communication network, or any other suitable network. The system bus 516 of the computing device 510 may represent any of the several types of bus structures (or combinations of bus structures), including a memory bus or memory controller, a peripheral bus, an accelerated graphics port, and a processor or local bus using any of a variety of bus architectures.

The memory 520 may include one or more computer-readable media configured to store data and/or program modules for implementing the techniques disclosed herein. For example, the memory 520 may host (or store) a basic input/output system (BIOS) 522, an operating system 524, one or more application programs 526, and program data 528 that can be accessed by the processor 512 for performing various functions disclosed herein.

The computing device 510 may further include a reservoir modeling package 550 in accordance with the teachings of the present disclosure. As depicted in FIG. 5, the reservoir modeling package 550 may be stored within (or hosted by) the memory 520. In alternate implementations, however, the reservoir modeling package 550 may reside within or be distributed among one or more other components or portions of the computing device 510. For example, in some implementations, one or more aspects of the reservoir modeling functionality described herein may reside in one or more of the processors 512, the I/O devices 514, the ASICs 515, or the memory 520.

In the following description, various techniques may be described in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media may include, but is not limited to, random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information and which can be accessed by the computing device 510. Combinations of any of the above should also be included within the scope of computer readable media.

Moreover, the computer-readable media included in the system memory 520 can be any available media that can be accessed by the computing device 510, including removable computer storage media (e.g. CD-ROM 520A) or non-removeable storage media. Computer storage media may include both volatile and nonvolatile media implemented in any method or technology for storage of information such as computer-readable instructions, data structures, program modules, or other data. Generally, program modules executed on the computing device 510 may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

It will be appreciated that the computing device 510 is merely exemplary, and represents only one example of many possible computing devices and architectures that are suitable for use in accordance with the teachings of the present disclosure. Therefore, the computing device 510 shown in FIG. 5 is not intended to suggest any limitation as to scope of use or functionality of the computing device and/or its possible architectures. Neither should computing device 510 be interpreted as having any dependency or requirement relating to any one or combination of components illustrated in the example computing device 510.

Embodiments of methods and systems for robust solution of sub-problems in accordance with the teachings of the present disclosure may be integrated into a wide variety of computational techniques. For example, FIG. 5 further shows that the exemplary reservoir modeling package 550 may include a grid generation portion 552, a geological modeling portion 554, a reservoir modeling portion 556, and a display portion 558. Any of these components (e.g. reservoir modeling portion 556, geological modeling portion 554, etc.) may be configured to provide for robust solution of sub-problems in accordance with the teachings of the present disclosure.

In general, unless otherwise stated herein, the components of the reservoir modeling package 550 depicted in FIG. 5 may be variously combined with one or more other components, or eliminated, to provide further possible embodiments of reservoir modeling packages in accordance with the teachings of the present disclosure. For example, in some embodiments, the grid generation portion 552 may be part of the geological modeling portion 554. Similarly, the display portion 558 may be part of the reservoir modeling portion 556, or the geological modeling portion 554, or any other portion of the reservoir modeling package 550. In further embodiments, any or all of the components of the reservoir modeling package 550 may be separated as discrete, stand alone utilities.

It will be appreciated that one or more components of the reservoir modeling package 550 (e.g. the reservoir modeling portion 556, the geological modeling portion 554, etc.) may incorporate one or more methods or systems in accordance with the teachings of the present disclosure. Similarly, of course, methods in accordance with the teachings of the present disclosure are not necessarily limited to reservoir modeling or geological formation modeling, but may be suitably applied in virtually any simulations that involve solution of systems of non-linear equations in a wide variety of technical fields (e.g. aerospace flowfield analyses, structural analyses, etc.).

Also, unless otherwise stated, it will be appreciated that one or more of the components of the reservoir modeling package 550 depicted in FIG. 5 may comprise conventional components. For example, in some implementations, at least some of the components of the geological modeling portion 554 may be provided from a conventional software package known as Petrel®, which is commercially-available from Schlumberger Technology Corporation. Similarly, in some implementations, at least some of the components of the reservoir modeling portion 556 may be from a conventional software package known as Eclipse®, which is also commercially-available from Schlumberger Technology Corporation.

In general, the use of methods in accordance with the teachings of the present disclosure may be performed separately, or may be combined with a wide variety of utilities and applications that employ generally known techniques, and therefore will not be described in detail herein. Such known techniques include, for example, those techniques described in the following references and incorporated herein by reference: “Petrel Version 2007.1—Petrel V R Configuration and User Guide,” by Schlumberger Technology Corporation (2007); “Archiving Geological and Reservoir Simulation Models—A Consultation Document,” UK Department of Trade and Industry, (2004); “Optimal Coarsening of 3D Reservoir Models for Flow Simulation,” by King et al., SPE (Society of Petroleum Engineering) 95759 (Oct. 2005); “Top-Down Reservoir Modeling,” by Williams et al., SPE 89974 (Sept. 2004); and U.S. Pat. No. 6,106,561 issued to Farmer and assigned to Schlumberger Technology Corporation. Other known techniques include, for example, those techniques employed in other conventional tools, including those tools used for simulation, modeling, and display available from or produced by, for example, Gemini Solutions, Inc., BP, Chevron, Roxar, Texas A&M University, and any other suitable techniques and tools.

Conclusion

Although embodiments of systems and methods for providing robust solutions for sub-problems arising from numerical simulations have been described in language specific to analyzing reservoirs and the like, it is to be understood that the subject of the appended claims is not necessarily limited to the specific features or methods described.

What is claimed is:

1. A method of solving a system of non-linear equations, comprising:
attempting to iteratively achieve a solution of a portion of the system using one or more iterative solution techniques;
determining that the attempting has failed to iteratively achieve the solution of the portion of the system using one or more iterative solution techniques; and
responsive to the determination that the attempting has failed, attempting to achieve an interval-based solution of the portion of the system using an interval-based solution technique,
wherein at least one above-identified operations is at least partially implemented using a processing device.

2. The method of claim 1, wherein attempting to achieve an interval-based solution of the portion of the system using an interval-based solution technique comprises:
attempting to achieve an interval-based solution of the portion of the system using an Interval Newton technique.

3. The method of claim 1, wherein the system of non-linear equations includes at least one well-model portion and at least one reservoir-model portion, and wherein attempting to iteratively achieve a solution of a portion of the system using one or more iterative solution techniques includes:
attempting to iteratively achieve a solution of the at least one well-model portion of the system using one or more iterative solution techniques.

4. The method of claim 3, further comprising:
iteratively achieving a reservoir solution of a reservoir-model portion of the system using one or more iterative solution techniques.

5. The method of claim 3, attempting to achieve an interval-based solution of the portion of the system using an interval-based solution technique includes:
attempting to achieve an interval-based solution of the at least one well-model portion of the system using an interval-based solution technique.

6. The method of claim 5, wherein attempting to achieve an interval-based solution of the at least one well-model portion of the system using an interval-based solution technique comprises:
attempting to achieve an interval-based solution of the at least one well-model portion of the system using an Interval Newton technique.

7. The method of claim 1, wherein attempting to iteratively achieve a solution of a portion of the system using one or more iterative solution techniques comprises:
attempting to iteratively achieve a solution of a portion of the system using one or more iterative solution techniques, wherein the system includes at least one of a well-model portion, a reservoir-model portion, a geological-model portion, a structure-model portion, or a flowfield-model portion.

8. The method of claim 1, further comprising:
iteratively achieving a second solution of a second portion of the system using one or more iterative solution techniques.

9. A method of simulating a system described by a plurality of non-linear equations, comprising:
attempting to iteratively achieve a solution of a first portion of the system using one or more iterative solution techniques;
determining that the attempting to iteratively achieve the solution has failed;
responsive to the determination that the attempting to iteratively achieve the solution has failed, attempting to achieve an interval-based solution of the first portion of the system using an interval-based solution technique;
determining whether a unique solution exists based on the attempting to achieve an interval-based solution;
if the unique solution exists, assigning the unique solution to the first portion of the system;
if the unique solution does not exist, closing the first portion of the system; and
attempting to iteratively achieve a solution of a second portion of the system using one or more iterative solution techniques;
wherein at least one above-identified operations is at least partially implemented using a processing device.

10. The method of claim 9, wherein attempting to achieve an interval-based solution of the first portion of the system using an interval-based solution technique comprises:
attempting to achieve an interval-based solution of the first portion of the system using an Interval Newton technique.

11. The method of claim 9, wherein the system includes at least one well-model portion and at least one reservoir-model portion, and wherein attempting to iteratively achieve a solution of a first portion of the system using one or more iterative solution techniques includes:
attempting to iteratively achieve a solution of the at least one well-model portion of the system using one or more iterative solution techniques.

12. The method of claim 11, wherein attempting to iteratively achieve a solution of a second portion of the system using one or more iterative solution techniques comprises:
attempting to iteratively achieve a solution of the at least one reservoir-model portion of the system using one or more iterative solution techniques.

13. The method of claim 9, further comprising:
performing at least one of setup operations or initialization operations of the system.

14. The method of claim 13, wherein performing at least one of setup operations or initialization operations of the system comprises:
forming a Jacobian and one or more residuals with respect to the first portion of the system prior to attempting to iteratively achieve a solution of a first portion of the system using one or more iterative solution techniques.

15. The method of claim 9, wherein performing at least one of setup operations or initialization operations of the system comprises:
assigning initialization values to variables of at least the first portion of the system prior to attempting to iteratively achieve a solution of a first portion of the system using one or more iterative solution techniques.

16. One or more computer-readable media bearing computer-readable instructions which, when executed, perform a process of solving a system of non-linear equations comprising:
attempting to iteratively solve a portion of the system using one or more iterative techniques;
determining that the attempting to iteratively solve the portion of the system using one or more iterative techniques has failed; and
responsive to determining that the attempting has failed, attempting to achieve an interval-based solution of the portion of the system using an interval-based technique,

17. The one or more computer-readable media of claim 16, wherein attempting to achieve an interval-based solution of the portion of the system using an interval-based technique comprises:
attempting to achieve an interval-based solution of the portion of the system using an Interval Newton technique.

18. The one or more computer-readable media of claim 16, wherein the system of non-linear equations includes at least one well-model portion and at least one reservoir-model portion, and wherein attempting to iteratively solve of a portion of the system using one or more iterative techniques includes:
attempting to iteratively solve the at least one well-model portion of the system using one or more iterative techniques.

19. The one or more computer-readable media of claim 18, wherein the method further comprises:
iteratively achieving a reservoir solution of the at least one reservoir-model portion of the system using one or more iterative techniques.

20. The one or more computer-readable media of claim 16, wherein the method further comprises:
determining whether a unique solution exists based on the attempting to achieve an interval-based solution;
if the unique solution exists, assigning the unique solution to the first portion of the system; and
if the unique solution does not exist, closing the first portion of the system.
